(19) United States
(12) Patent Application Publication
(10) Pub. No.: US 2013/0125100 A1
(43) Pub. Date: May 16, 2013

(54) COMPUTER SYSTEM AND METHOD FOR COMPILING PROGRAM CODE AND ASSIGNING ADDRESS SPACES

(71) Applicants: Bixia Zheng, Palo Alto, CA (US); Benedict R. Gaster, Santa Cruz, CA (US); Dz-Ching Ju, Saratoga, CA (US)

(72) Inventors: Bixia Zheng, Palo Alto, CA (US); Benedict R. Gaster, Santa Cruz, CA (US); Dz-Ching Ju, Saratoga, CA (US)

(73) Assignee: ADVANCED MICRO DEVICES, INC., Sunnyvale, CA (US)

(21) Appl. No.: 13/296,967

(22) Filed: Nov. 15, 2011

(51) Int. Cl. G06F 9/45

(52) U.S. Cl. 717/140

(57) ABSTRACT

A computer system is provided for compiling program code and a method for compiling program code by a processor. The method, for example, includes, but is not limited to, receiving, by the processor, the program code and compiling, by the processor, the program code, wherein the processor, when compiling the program code, parses the program code and assigns a default address space qualifier to each member functions without a defined address space qualifier and, when the member function is used, infers an address space for each default address qualifier based upon how the respective member function is being used.

### TECHNICAL FIELD

The following relates to computer systems, and more particularly to a computer system for compiling program code and assigning memory address space.

### BACKGROUND

C++ is a widely used programming language which allows member functions, otherwise known as functions, to be overloaded. However, in order for C++ program code to compile correctly on a traditional C++ compiler, the member functions must each have an address space so that when the member function is overloaded, the compiler knows which member function to use. However, in other programming languages, such as OpenCL and Embedded C, functions do not have to have an assigned address space. Accordingly, program code from OpenCL and Embedded C will typically not compile on a C++ compiler.

### SUMMARY OF EMBODIMENTS

In accordance with one embodiment, a method for compiling program code by a processor is provided. The method includes, but is not limited to, receiving, by the processor, the program code and compiling, by the processor, the program code, wherein the processor, when compiling the program code, parses the program code and assigns a default address space qualifier to each member function without a defined address space qualifier and, when the member function is used, it infers an address space for each default address qualifier based upon how the respective member function being used.

In accordance with another embodiment, a computer system is provided. The computer system includes, but is not limited to, a memory having a plurality of address spaces and a processor coupled to the memory. The processor may be configured to receive a location of program code in the memory, parse the program code to determine if a member function in the program code has an undefined address space, and assign one of the address spaces in the memory to the member function.

In accordance with yet another embodiment, a method for compiling program code by a processor is provided. The method includes, but is not limited to, receiving, by the processor, the program code, creating, by the processor, a lookup table assigning an address space qualifier to each member functions without a defined address space qualifier based upon how the member function is being used, and compiling, by the processor, the program code using the lookup table.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DESCRIPTION OF THE DRAWING FIGURES

Exemplary embodiments will hereinafter be described in conjunction with the following drawing figures, wherein like numerals denote like elements; and

FIG. 1 is a block diagram of an exemplary computer system in accordance with an embodiment;

FIG. 2 is flow chart illustrating an exemplary method for compiling program code, in accordance with an embodiment; and

FIG. 3 is flow chart illustrating another exemplary method for compiling program code, in accordance with an embodiment.

### DETAILED DESCRIPTION

According to various exemplary embodiments, a computer system for compiling C++ code and a method for compiling C++ code is provided. The computer system, for example, includes a processor which assigns an address space to member functions that do not have a defined address space. Accordingly, program code from an OpenCL or Embedded C environment can be directly imported into a C++ environment.

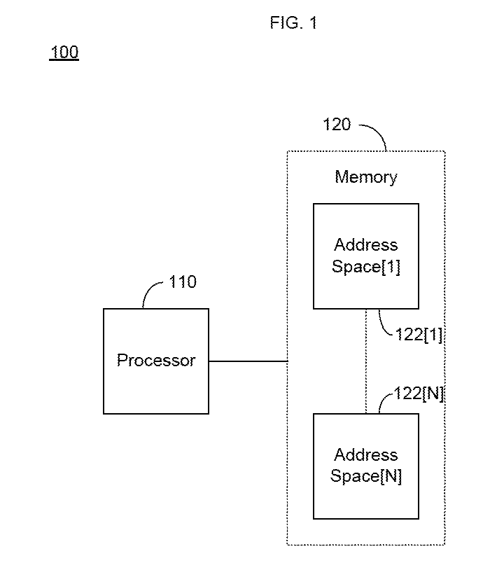

FIG. 1 is a block diagram of an exemplary computer system 100. The computer system 100 includes a processor 110 and at least one memory 120. The processor 110 and memory may be connected within a computer or may be connected via a network (not illustrated). The processor 110 may be any type of processor capable of compiling C++ program code. For example, the processor 110 could be a central processing unit (CPU), a graphical processing unit (GPU), a physics processing unit (PPU), an application specific integrated circuit (ASIC), a field-programmable gate array, a microprocessor, or any other logic circuit.

The memory 120 may be a single discrete memory unit or multiple memory units. For example, the memory could be a hard disk drive (magnetic platters, solid-state, or a combination thereof), random access memory (RAM) of any type, flash memory, or any combination thereof. The memory 120 has a C++ compiler stored thereon which is accessible and executable by the processor 110.

The memory 120 has multiple address spaces 122(1) to 122(N). The address spaces may include, but are not limited to, a global address space, a local address space, a private address space and a constant address space.

As discussed above, C++ typically requires an address space to be explicitly assigned to each member function. Member functions, which may otherwise be known as functions or classes, can be used to interact with data contained within user defined types. User defined types provide flexibility in the “divide and conquer” scheme in program writing. In other words, one programmer can write a user member function with an assigned address space and guarantee an interface. Another programmer can write the main program with that expected interface. The two pieces are put together and compiled for usage.

C++ member functions can be overloaded. In other words, multiple member functions can exist with the same name on the same scope, but the member functions typically would have different signatures. A member function's signature is comprised of the member function's name and the type and order of the member function's parameters. In some embodiments, for example, the type may be the address space associated with the member function.

However, when program code is imported from OpenCL or Embedded C into a C++ environment, the program may not include address space qualifiers for all of the functions. As a result, the program code would fail to compile in C++.

In order to compensate for the shortcomings of existing C++ compilers, the computer system 100 assigns address spaces when necessary, as discussed in further detail below.

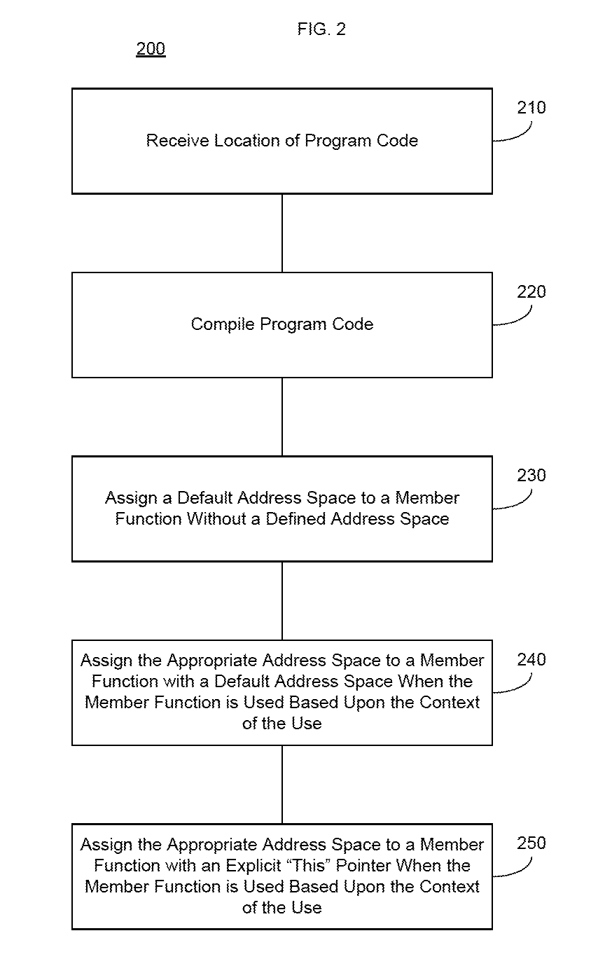

FIG. 2 illustrates a method 200 for compiling program code, in accordance with an embodiment. The method 200 typically begins when the processor 110 receives a location of the program code in memory 120. Once the processor 110 has a location of the program code in memory 120, the processor 110 can begin compiling the program code. (Step 220).

When compiling the program code, the processor translates the program code from a high-level programming language (such as C++) to a lower level language (e.g., assembly language or machine code). The processor 110 may perform lexical analysis, preprocessing, parsing, semantic analysis (Syntax-directed translation), code generation, and code optimization when compiling the code.

When performing the parsing, the processor 110 analyzes each line of code. Consider the following basic structure:

struct Foo
{

Foo(void);
{
// implement default constructor
}

}

This is a standard C++ class definition that has no notion of address space qualifiers. There is not even a mention of a pointer type. However, C++ has an implicit “this” pointer having a private address space. This is usually an immutable reference or pointer which refers to the current object. Accordingly, the above code could have been written as:

struct Foo
{

Foo(_{——}private Foo * this);
{
// implement default constructor
}

}

However, in typical C++ compilers the following kernel would not be valid.

_{——}kernel (_{——} global Foo * gFoo, _{——}local * Foo)
{

Foo pFoo;
*lFoo = Foo( );

}

In typical compilers, the line “Foo pFoo” would be valid since the this pointer has a default constructor_private. However, the line “*1Foo=Foo( )” would be invalid since there is no default constructor for a local address space.

Accordingly, to overcome the issues of prior compilers, when the processor 110 is parsing the program code and encounters a member function without an address space, the processor assigns a default address space to the member function. (Step 230). Further, when the processor 110 encounters the member function having a default address space, the processor 110 automatically generates a version of the member function with the correct address space qualification. (Step 240). The processor 110 determines the correct address space qualifiers by parsing the lines of code and determining which address space qualifiers apply based upon how the member function was being used. For example, the processor 110, after parsing the kernel written above (which calls for a private pointer and a local pointer), would create:

struct Foo
{

Foo(_{——}private Foo * this);
{
// implement default constructor
}
Foo(_{——}local Foo * this);
{
// implement default constructor
}

}

Any address space qualifier can be applied to a member function. Furthermore, the processor 110 may recognize several new address space qualifiers. One exemplary address space qualifier is_any, where_any is an explicit way of saying auto-generate for all address spaces. Another exemplary address space qualifier is _address_qualifier(n), where_address qualifier(n) takes an integer argument and can combine with integer template arguments. For example:

template <int n>
class Foo
{

Foo(void) _{——}address_qualifier(n)
{

//default constructor implementation

}

};

While the above example uses constructors, the assignment of address qualifiers can be applied to any type of member function.

The processor 110, while parsing the program code, also looks for explicit use of the “this” pointer. Consider the following structure:

struct Foo
{

Foo * getinstance(void);
{

return this;

}

};

Overloading of the return type is invalid and would cause an error in typical C++ compiler. Further, in some instances the program developer may want to define values of the same type as the “this” pointer within the member function itself For example, consider the following code:

struct Foo
{

Foo * getinstance(void);
{

If(expr) {

Foo * foo;
Return foo;

}

return this;

}

};

As with the previous example, the code would not compile in a typical C++ compiler since the return can not be overloaded.

Accordingly, to overcome to the restrictions of prior systems, the computer system 100 takes advantage of the decltype feature in the forthcoming version of C++ known as C++11 to allow implicit deduction of address space qualifiers with the “this” pointer when used within the member function. (Step 250). Decltype(expr) drops the outer most qualifier for the type of expression. Consider the following code:

_{——}global int * globalPtrInt;
_{——}local decltype(globalPtrInt) localIntPtr;

Because Decltype(expr) drops the outer most qualifier for the type of expression, the localIntPtr is a pointer to an integer in the_local address space.

Returning to the prior example, the code can be rewritten to take advantage of the decltype feature as follow:

struct Foo
{

Foo(decltype(this) & rhs;
{

//implement copy constructor

}

getInstance(void) −> decltype(this)
{

If(expr) {

Foo * foo;
Return foo;

}

return this;

}

};

Since the processor 110 infers the address space of the explicit “this” pointer (i.e., step 250), the following kernel based upon the structure above is now valid.

_{——}kernel (_{——} global Foo * gFoo, _{——}local * IFoo)
{

IFoo(*gFoo);
}

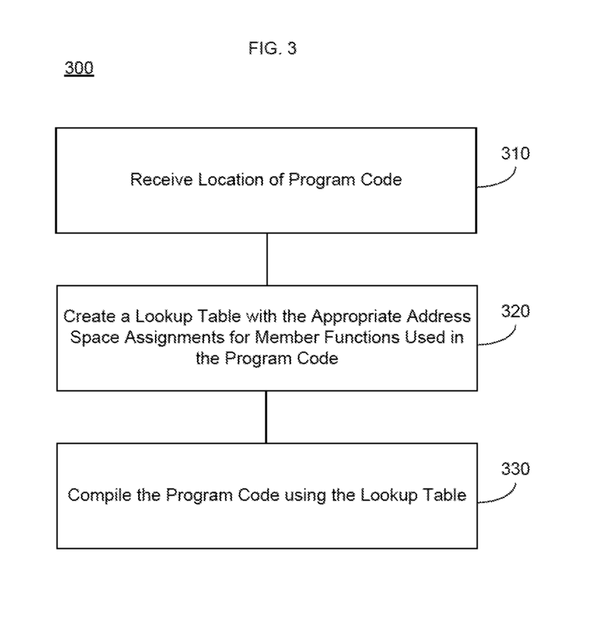

FIG. 3 illustrates another method for compiling program code, in accordance with an embodiment. The method 200 typically begins when the processor 110 receives a location of the program code in memory 120. Once the processor 110 has a location of the program code in memory 120, the processor 110 parses the program code looking for member functions without a defined address space and for explicit uses of the “this” pointer. The processor then, based upon the context of how the member functions are being used, creates a lookup table storing the appropriate address space assignments for the member functions. (Step 320). The processor 110 can then compile the code using the lookup table for the appropriate address space assignments. (Step 330).

By using the processor 110 to infer the correct address space qualifiers for member functions not having a defined address space and for explicit this pointers, the processor 110 can directly import OpenCL and Embedded C program code into a C++ environment and compile the program code without having to make substantial changes to the code.

Generally speaking, the various functions and features of methods 200 and 300 may be carried out with any sort of hardware, software and/or firmware logic that is stored and/or executed on any platform. Some or all of methods 200 and 300 may be carried out, for example, by the processor 110 illustrated in FIG. 1. Further, various functions shown in FIGS. 2 & 3 may be implemented using software or firmware logic. The particular hardware, software and/or firmware logic that implements any of the various functions shown in FIGS. 2 & 3, however, may vary from context to context, implementation to implementation, and embodiment to embodiment in accordance with the various features, structures and environments set forth herein. The particular means used to implement each of the various functions shown in FIGS. 2 & 3, then, could be any sort of processing structures that are capable of executing software and/or firmware logic in any format, and/or any sort of application-specific or general purpose hardware, including any sort of discrete and/or integrated circuitry. The various methods described above may be accomplished, for example, in conjunction with a computer readable medium (e.g., ROM, RAM, or other storage device) that stores data and instructions for compiling program code and assigning address spaces.

The term “exemplary” is used herein to represent one example, instance or illustration that may have any number of alternates. Any implementation described herein as “exemplary” should not necessarily be construed as preferred or advantageous over other implementations.

Although several exemplary embodiments have been presented in the foregoing description, it should be appreciated that a vast number of alternate but equivalent variations exist, and the examples presented herein are not intended to limit the scope, applicability, or configuration of the invention in any way. To the contrary, various changes may be made in the function and arrangement of the various features described herein without departing from the scope of the claims and their legal equivalents.

What is claimed is:

1. A method for compiling a program code by a processor, comprising:
parsing, by the processor, the program code and assigning, by the processor a default address space qualifier to each member function without a defined address space qualifier; and
when the member function is used, inferring, by the processor, an address space for each default address qualifier based upon how the respective member function is being used.

2. The method of claim 1, further comprising:
parsing, by the processor, the program code for explicit uses of a this pointer in a member function; and
assigning, by the processor, an second address space for the this pointer based upon how the member function is being used.

3. The method of claim 1, wherein a compiler used by the processor to compile the program code is a C++ compiler.

4. The method of claim 3, wherein the program code is OpenCL code.

5. The method of claim 3, wherein the program code is Embedded C code.

6. A computer system, comprising:
a memory having a plurality of address spaces; and
a processor coupled to the memory,
wherein the processor is further configured to:
receive a location of a program code in the memory;
parse the program code to determine if a member function in the program code has an undefined address space; and
assign one of the plurality of address spaces as a first assigned address space in the memory to the member function.

7. The computer system of claim 6, wherein the memory comprises a local address space, a private address space, a global address space and a constant address space.

8. The computer system of claim 6, wherein the processor is further configured to determine a second assigned address space to assign to the member function based upon how the member function is being used.

9. The computer system of claim 6, wherein the processor is further configured to:
parse the program code for an explicit use of a this pointer within a member function; and
assign an address space to the member function based upon how the member function is being used.

10. The computer system of claim 8, wherein the processor is further configured to:
store the first assigned address space and the second assigned address space in the memory; and
compile the program code using the first assigned address space and the second assigned address space in the memory.

11. The computer system of claim 6, wherein the processor is further configured to assign one of the plurality of address spaces in the memory to the member function as the program code is being compiled.

12. The computer system of claim 11, wherein a compiler used by the processor to compile the program code is a C++ compiler.

13. The computer system of claim 12, wherein the program code is OpenCL code.

14. The computer system of claim 12, wherein the program code is Embedded C code.

15. A method for compiling a program code by a processor, comprising:
creating, by the processor, a lookup table assigning an address space qualifier to each member functions without a defined address space qualifier based upon how the member function is being used; and
compiling, by the processor, the program code using the lookup table.

16. The method of claim 15, further comprising:
parsing, by the processor, the program code for explicit uses of a this pointer in a member function; and
storing, by the processor, an address space assignment for the member function in the lookup table based upon how the member function is being used.

17. The method of claim 15, wherein a compiler used by the processor to compile the program code is a C++ compiler.

18. The method of claim 17, wherein the program code is OpenCL code.

19. The method of claim 17, wherein the program code is Embedded C code.

20. The method of claim 15, wherein an assigned address space is selected from a group comprising a local address space, a global address space, a constant address space and a private address space.
